(19) United States
(12) Patent Application Publication
(10) Pub. No.: US 2023/0060735 A1
(43) Pub. Date: Mar. 2, 2023

(54) MEDIA PROCESSING APPARATUS AND METHOD OF SAME

(71) Applicant: ENGINEERED ABRASIVES, INC., Alsip, IL (US)

(72) Inventor: Michael J. WERN, Alsip, IL (US)

(21) Appl. No.: 17/672,360

(22) Filed: Feb. 15, 2022

Related U.S. Application Data
(60) Provisional application No. 63/239,882, filed on Sep. 1, 2021.

(51) Int. Cl. B24C 9/00; B07B 7/06; B07B 9/00; B03C 1/12

(52) U.S. Cl. CPC B24C 9/006; B07B 7/06; B07B 9/00; B03C 1/12; B03C 2201/20; B03C 2201/28

(57) ABSTRACT

A part processing assembly comprising including a media collection device that is adapted to receive used media from a media-blasting chamber. A transport mechanism, coupled to the media collection device, transports used media to a media reclaim system. A first separation device is used to perform a filtering process on the used media to create non-useable media and useable media. A second separation device is configured to apply a magnetic field to the useable media to create recycled media for use in the media-blasting chamber.

### CROSS REFERENCE TO RELATED APPLICATIONS

The application claims priority to U.S. Provisional Application No. 63/239,882.

### BACKGROUND OF THE INVENTION

When media blasting a workpiece, such as a gear, the workpiece is placed in a closed chamber and the blasting system is actuated, whereby media are mixed with air. After mixing of the media and air, a stream of the air/media mixture is directed against the workpiece, often through increased or high-speed application. This process is referred to as peening. The peening process is configured to affect and change the characteristics of the surface of the workpiece, and in particular increase the strength of the workpiece. Accordingly, media blasting a workpiece improves the durability of a workpiece. An example of peening is described in U.S. Pat. No. 5,272,897, and the disclosure of the 5,272,897 patent is hereby incorporated in its entirety by this reference. Other exemplary methods of media blasting and finishing are provided in U.S. Pat. Nos. 8,453,305, 10,773,358, which are hereby incorporated in their entirety by this reference.

As part of the peening process, it is common to recycle and reuse the peening material. However, due to the force/speed of the peening process, not all of the peening material will be suitable for reuse. Some of the peening material will degrade because particles of peening break off or become lodged on the surface of the workpieces. Also, particles from the part being processed may break off and be retained in the used peening material. Accordingly, before peening material reused it is filtered and separated and only material of a certain size is recycled and reused in the peening process. However, even after this filtering is performed, small (including microscopic) pieces of workpiece material and degraded peening material may remain in the peening material. Accordingly, what is needed are systems and methods for post processing of peening material to remove particulate matter.

This background information is provided to offer some information believed by the applicant to be of possible relevance to the present disclosure. No admission is intended, nor should such admission be inferred or construed, that any of the preceding information constitutes prior art against the present disclosure. Other aims, objects, advantages and features of the disclosure will become more apparent upon reading of the following non-restrictive description of specific embodiments thereof, given by way of example only with reference to the accompanying drawings.

### OBJECTS AND SUMMARY OF THE INVENTION

An object of the present application is to remove or reduce unusable particulate matter from recycled peening material used in a peening process. In illustrative embodiments, the peening material is collected after it is used in a peening process. The peening material undergoes a multi-step cleaning process after it is used in peening to remove or reduces undesirable particles or particulates that are present in the peening material.

These and other advantages and features will become more apparent from the following description taken in conjunction with the drawings.

### BRIEF DESCRIPTION OF THE DRAWINGS

The present invention will not be described, by way of example, with reference to the accompanying drawings in which.

FIG. 1 is an elevated view of a media blasting apparatus;

FIG. 2 is an enlarged view of the media reclaim system used in the media blasting apparatus of FIG. 1;

FIGS. 3 and 4 are enlarged view of a magnetic separator device usable in the media blasting apparatus of FIG. 1.

### DETAILED DESCRIPTION OF PREFERRED EMBODIMENTS

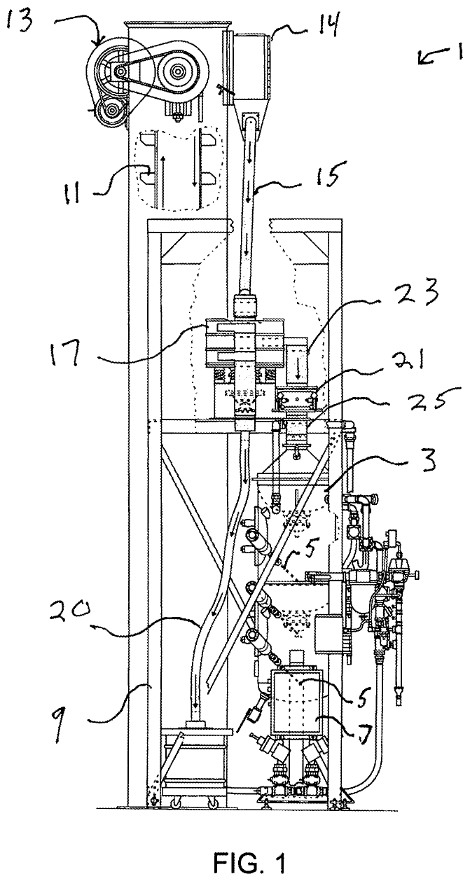

Referring FIG. 1, a media blasting apparatus according to the one aspect of the application, generally indicated by the number 1.

The media blasting apparatus will now be described. The media blasting apparatus 1 includes a blasting cabinet or chamber 3, in which one or more streams of media 5 are directed against a workpiece (not shown). Such media may comprise, for example, cut wire, glass beads, ceramic beads or fine steel beads. As the media engages with the surface of the workpiece, microscopic or small particles from the media may be retained or lodged into the surface of the workpiece due to the force and direction of the blasting stream. Further, the cabinet 3 is connected to a media collection device 7 for collecting the media that fall after collision with the workpiece. In one example, the media collection device 7 may be a cabinet media hopper. The fallen media will include broken pieces of media which have been recycled, as well as virgin or unbroken pieces, and particles from the workpiece. Media of sufficient size is reclaimed in this apparatus 1, as discussed below, and mixed with virgin media to be reused in the blasting operation. Accordingly, it is understood that media that is reused should not include pieces of media that are undesirable for the further peening process.

A media transport device 9 connects the media collection device 7 to a media reclaim system. In one example, the media transport device 9, which connects the media collection 7 device to the media reclaim system, is an elevator system. In one example, the elevator system transports fallen media to the media reclaim system through utilization of at least one bucket 11. The at least one bucket 11 is driven vertically by a belt drive system 13 from the media collection device 7 to the media reclaim system. The at least one bucket 11 may be connected by conduit to the media collection device 7 where it is filled with fallen media. It is transported to the media reclaim system where it is emptied into a funnel assembly 14. The belt drive system 13 then drives the at least one bucket 11 back to the media collection device 7 to be refilled with fallen media.

As another example, the fallen media may be transported from media collection device 7 to the media reclaim system through another mechanism. For example, the media collection device may comprise a cabinet media hopper, which is connected to a pressurized air supply. The pressurized air supply may provide an air flow to the cabinet media hopper and force the collected fallen media up through a conduit to the media reclaim system.

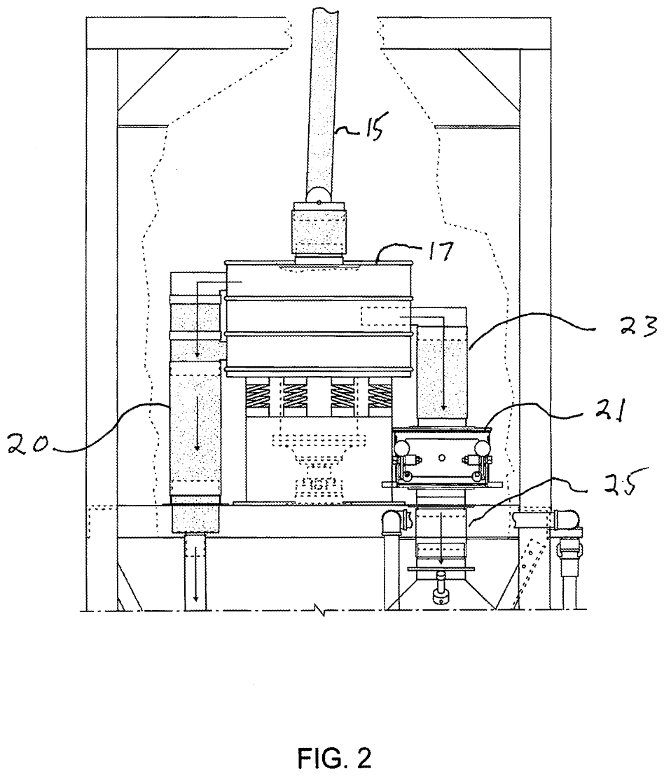

Referring now to FIGS. 1 and 2, the media reclaim system 10 includes a conduit 15 for conveying collected media from funnel assembly 14 to a first separation device 17. In one example, the first separation device 17 may be a two-deck system comprising a top screen and a bottom screen. In one embodiment, the top screen is between 20 and 40 mesh gauge and the bottom screen is between 170-200 mesh gauge. The separation device 17 generally separates the fallen media into unusable media and media of sufficiently large size to be useable in a future peening operation. Such useable media may be unbroken media and broken media of sufficient size for use in a peening operation. Unusable media may be fines or dust which cannot be reused in a future peening operation. The separator screens and in one example are constantly vibrated to increase the efficiency of separation. In one example, unusable media is transported by conduit to a waste receptacle 19.

In one embodiment, the media reclaim system includes a second separation device 21. The second separation device 21 may be used to perform a second separation operation on the fallen media.

Referring to FIG. 2, in one example, the second separation device 21 may be a magnetic separator device. The magnetic separator device may include one or more magnets. Reusable fallen media is transported via conduit 23 from first separation device 17 to second separation device 21. It is possible that, despite the fallen media undergoing a first separation operation through employment of first separation device 17, there may be additional small particles or dust attached to or comingled with the reusable fallen media. In one example, the small particles or dust may comprise metallic pieces that have broken or been separated from the work piece during a peening operation. In one example, if metallic peening material is used, the small particles or dust may comprise pieces of metallic peening material or dust that have been created through degradation of the peening material. Accordingly, magnetic separator is adapted and configure to remove such small particles and dust from the fallen media. In one example, magnetic separator employs at least one magnet to remove such small particles and dust from the reusable media.

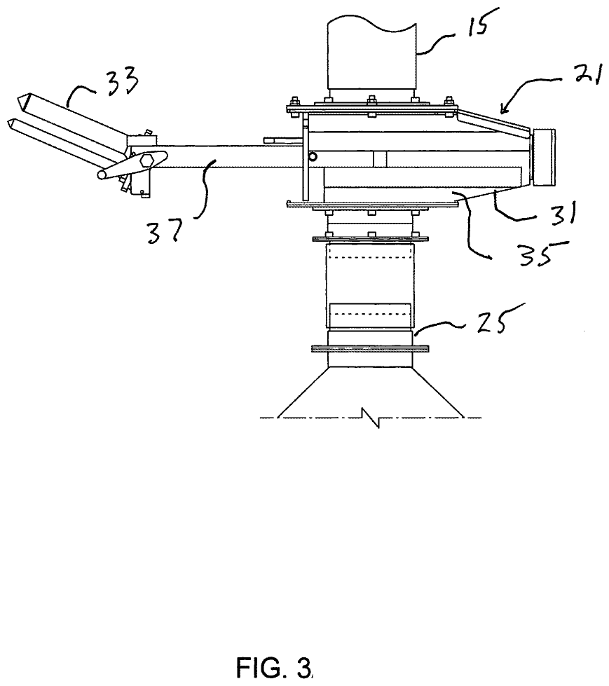

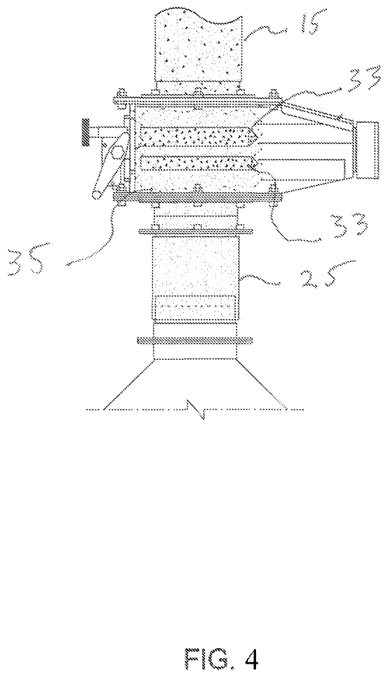

Referring to FIGS. 3 and 4, in one example, the second separation device 21 may comprise a grate magnet assembly 31. The grate magnet assembly 31 may include at least one magnet 33, which is disposed within a housing 35. The at least one magnet 33 may be positioned on a tray 37, which slides in and out of housing 35. As the reusable media passes through the grate magnet assembly, small particles and dust may be attracted to the at least one magnet and adhere to the surface. In one application, utilizing glass peening media, the at least one magnet may attract any metal particles or dust that has been introduced into the fallen media by collision of the peening material with a workpiece.

At a certain point, the at least one magnet 33 may become saturated with material and have to be removed from grate magnet assembly and cleaned. In one example, different magnets may be introduced into magnet assembly depending on the type of peening material and the type of workpiece. For instance, stronger magnets may be used to attract larger particles and smaller magnets may be used to attract smaller particles depending on the tolerance of the particular peening operation for particles of various sizes.

Referring now to FIG. 1, the second separation device 21 of the media blasting apparatus 1 may be connected to a double pressure chamber 3 via a conduit 25. A media path may be defined between the media collection device 7 and the pressure chamber 3. In a preferred embodiment, the double pressure chamber is held between 70 and 80 psi. The conduit 25 delivers the reclaimed reusable media to the double pressure chamber 3 where the reclaimed and reusable media are mixed with virgin media. In a preferred embodiment, the reclaimed media are of a mesh size greater than 100 mesh and the virgin media are of a mesh size between 60-100 mesh and preferably between 60-80 mesh. As stated previously, in the present invention, the media of the first medial blasting apparatus may comprise glass, ceramic, or fine steel beads. The virgin media are supplied to the double pressure chamber 3 through a plurality of media supply valves 29. The double pressure chamber is also coupled to a media sensor monitor for automatically controlling the supply of the virgin media. The supply of the virgin media is controlled to ensure adequate peening of the workpiece. Specifically, the supply of the virgin media is controlled to ensure that adequate compression stress is provided to the workpiece so that a sufficiently high fatigue strength is obtained upon blasting. The double pressure chamber 3 may further include a media metering on/off valve.

The applicant has provided description and figures that are intended as an illustration of certain embodiments of the invention and are not intended to be construed as containing or implying limitation of the invention to those embodiments. It will be appreciated that, although applicant has described various aspects of the invention with respect to specific embodiments, various alternatives and modifications will be apparent from the present disclosure which are within the spirit and scope of the present invention.

What I claim is:

1. A part processing assembly comprising:
a media collection device that is adapted to receive used media from a media-blasting chamber;
a transport mechanism, coupled to the media collection device, that transports the used media to a media reclaim system; wherein the media reclaim system comprises:
a first separation device to perform a filtering process on the used media to create non-useable media and useable media; and
a second separation device configured to apply a magnetic field to the useable media to create recycled media for use in the media-blasting chamber.

2. The part processing assembly of claim 1, wherein the second separation device applies an electromagnetic field to the useable media.

3. The part processing assembly of claim 1, wherein the second separation device applies a magnetic field through employment of at least one magnet.

4. The part processing assembly of claim 3, wherein the second separation device applies a magnetic field through employment of at least two magnets.

5. The part processing assembly of claim 3, wherein the second separation device is a grate magnet assembly.

6. The part processing assembly of claim 5, wherein the grate magnet assembly includes a housing and a tray slidable within the assembly.

7. The part processing assembly of claim 6, wherein the housing comprises a top side, a bottom side, and two opposing sidewalls.

8. The part processing assembly of claim 7, wherein the top side includes an inlet that is coupled to an outlet of the first separation device.

9. The part processing assembly of claim 8, wherein the bottom side includes an outlet that is coupled to an inlet of a pressure chamber.

10. The part processing assembly of claim 6, wherein the at least one magnet is disposed within the tray and extends between the two opposing sidewalls.

11. A media reclaim system to process used media from a media blasting chamber for reuse in the blasting chamber, the media reclaim system comprising:
a first separation device to perform a filtering process on the used media to create non-useable media and useable media; and
a second separation device configured to apply a magnetic field to the useable media to create recycled media for use in the media-blasting chamber.

12. The part processing assembly of claim 11, wherein the second separation device applies an electromagnetic field to the useable media.

13. The part processing assembly of claim 11, wherein the second separation device applies a magnetic field through employment of at least one magnet.

14. The part processing assembly of claim 13, wherein the second separation device applies a magnetic field through employment of at least two magnets.

15. The part processing assembly of claim 13, wherein the second separation device is a grate magnet assembly.

16. The part processing assembly of claim 15, wherein the grate magnet assembly includes a housing and a tray slidable within the assembly.

17. The part processing assembly of claim 16, wherein the housing comprises a top side, a bottom side, and two opposing sidewalls.

18. The part processing assembly of claim 17, wherein the top side includes an inlet that is coupled to an outlet of the first separation device.

19. The part processing assembly of claim 18, wherein the bottom side includes an outlet that is coupled to an inlet of a pressure chamber.

20. The part processing assembly of claim 16, wherein the at least one magnet is disposed within the tray and extends between the two opposing sidewalls.
